(19) United States
(12) Patent Application Publication
(10) Pub. No.: US 2017/0019226 A1
(43) Pub. Date: Jan. 19, 2017

(54) Preamble Detection on a Communication Channel

(71) Applicant: QUALCOMM Incorporated, San Diego, CA (US)

(72) Inventors: Lawrence Winston Yonge, III, Summerfield, FL (US); Hassan Kaywan Afkhami, San Jose, CA (US); Purva Rameshchandra Rajkotia, Orlando, FL (US)

(21) Appl. No.: 14/798,681

(22) Filed: Jul. 14, 2015

(51) Int. Cl. H04L 5/00

(52) U.S. Cl. CPC H04L 5/0044; H04L 5/006; H04L 5/0062

(57) ABSTRACT

Described herein are apparatuses for receiving preamble information via a channel between a first device and a second device. An apparatus is configured to scan a band of multiple carriers associated with the channel, determine a first carrier associated with the channel from the band of multiple carriers, wherein a first channel quality metric associated with the first carrier is greater than a threshold channel quality metric, receive, on the first carrier, the preamble information from the first device, determine a second carrier associated with the channel from the band of multiple carriers, wherein a second channel quality metric associated with the second carrier is greater than the threshold channel quality metric, receive, on the second carrier, the preamble information from the first device, and determine, based on receipt of the preamble information from the first device, a start of a data packet transmission from the first device.

### TECHNICAL FIELD

The present application generally relates to reception of information on a communication channel.

### BACKGROUND

A communication channel between a transmitting device and a receiving device may include one or more carriers, each carrier being associated with a carrier frequency. Messages transmitted between a transmitting device and a receiving device may each begin with a preamble followed by a message payload. Sometimes, a receiving device fails to detect the preamble. If the receiving device does not detect the preamble, it will also fail to prepare for the message payload transmission. Thus, the preamble can be a communication bottleneck, and robust preamble detection is important.

### SUMMARY

Described herein are various implementations of receiving preamble information via a channel between a first device and a second device. In some embodiments, an apparatus is provided for receiving preamble information via a channel at a second device from a first device. The apparatus comprises an I/O module, and a processor coupled to the I/O module. The processor is configured to scan a band of multiple carriers associated with the channel, determine a first carrier associated with the channel from the band of multiple carriers associated with the channel, wherein a first channel quality metric associated with the first carrier is greater than a threshold channel quality metric, receive, on the first carrier, the preamble information from the first device, determine a second carrier associated with the channel from the band of multiple carriers associated with the channel, wherein a second channel quality metric associated with the second carrier is greater than the threshold channel quality metric, receive, on the second carrier, the preamble information from the first device, and determine, based on the receipt of the preamble information on the first carrier and the second carrier, a start of a data packet transmission from the first device.

In some embodiments, the first or second channel quality metric may be a first or second signal-to-noise ratio (SNR) or bit error rate (BER). This disclosure is not limited to any particular channel quality metric.

In some embodiments, an average channel quality metric associated with the multiple carriers in the band of multiple carriers is equal to or greater than the threshold channel quality metric.

In some embodiments, the processor is configured to measure first amplitude and phase variation associated with the preamble information received on the first carrier, and second amplitude and phase variation associated with the preamble information received on the second carrier, and determine the first channel quality metric for the first carrier based on the first amplitude and phase variation and the second channel quality metric for the second carrier based on the second amplitude and phase variation.

In some embodiments, the processor is further configured to separate, in a frequency domain, the preamble information received on the first carrier from the preamble information received on the second carrier.

In some embodiments, the processor is further configured to compare the preamble information received on the first carrier and the preamble information received on the second carrier with known preamble information, determine the preamble information received on the first carrier matches the known preamble information, and determine the preamble information received on the second carrier matches the known preamble information.

In some embodiments, the processor is further configured to compare the preamble information received on the first carrier and the preamble information received on the second carrier with known preamble information, determine a degree of match between the preamble information received on the first carrier and the known preamble information is equal to or greater than a threshold level, and determine a degree of match between the preamble information received on the second carrier and the known preamble information is equal to or greater than the threshold level.

In some embodiments, the processor is further configured to receive the preamble information on a third carrier, and disregard the third carrier based on determining an amplitude associated with the preamble information received on the third carrier is at least two times greater than an amplitude associated with the preamble information received on the first carrier or the second carrier.

In some embodiments, the processor is further configured to receive message payload information at the second device from the first device, the message payload information being received after the preamble information is received on both the first and second carriers.

In some embodiments, the apparatus is integrated into the second device.

In some embodiments, the processor is further configured to compare the preamble information received on the first carrier or the second carrier with known preamble information, and determine whether the preamble information matches the known preamble information.

In some embodiments, the processor is further configured to determine a start of a data transmission based on determining the preamble information matches the known preamble information.

In some embodiments, the processor is further configured to ignore a carrier affected by narrow band interference equal to or greater than a threshold interference level.

In some embodiments, a method is provided for receiving preamble information via a channel at a second device from a first device. The method comprises scanning, using a computing device processor associated with the second device, a band of multiple carriers associated with the channel, determining, using the computing device processor, a first carrier associated with the channel from the band of multiple carriers associated with the channel, wherein a first channel quality metric associated with the first carrier is greater than a threshold channel quality metric, receiving, using the computing device processor, on the first carrier, the preamble information from the first device, determining, using the computing device processor, a second carrier associated with the channel from the band of multiple carriers associated with the channel, wherein a second channel quality metric associated with the second carrier is greater than the threshold channel quality metric, receiving, using the computing device processor, on the second carrier, the preamble information from the first device, and determining, using the computing device processor, based on the receipt of the preamble information on the first carrier and the second carrier, a start of a data packet transmission from the first device.

In some embodiments, an apparatus is provided for receiving preamble information via a channel at a second device from a first device. The apparatus comprises means for performing the various methods described herein.

In some embodiments, a computer readable medium is provided for providing instructions for receiving preamble information via a channel between a first device and a second device. The computer readable medium comprises computer executable code configured to perform the various methods described herein.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 is a block diagram illustrating a network system for communicating between nodes;

FIG. 2 is a diagram of a system environment for communicating information (e.g., preamble information, message payload information, etc.) via a communication channel from a first device to a second device; and

FIG. 3 is a diagram of a method for receiving preamble information via a channel at a second device from a first device.

Although similar reference numbers may be used to refer to similar elements for convenience, it can be appreciated that each of the various example implementations may be considered distinct variations.

### DETAILED DESCRIPTION

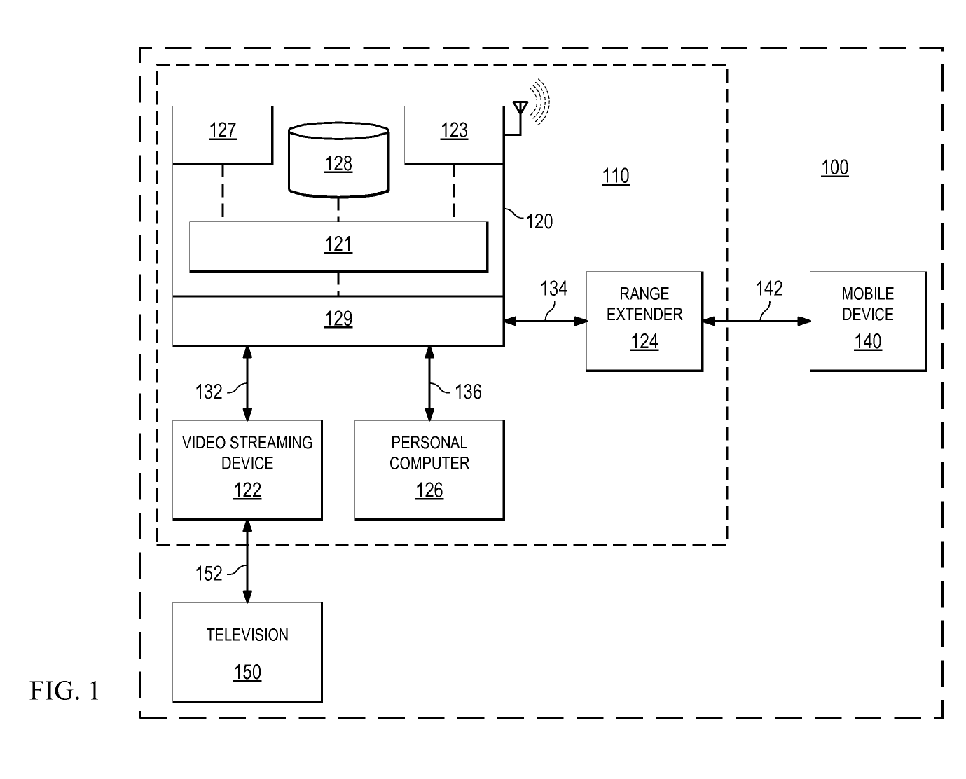

FIG. 1 shows a block diagram illustrating a system 100 for communicating between nodes on a network. The system 100 includes a powerline communication (PLC) network that may be deployed in a home, work place, automobile, or other environment having a powerline infrastructure. The system 100 may comprise an access point 120 that receives connectivity to an external network (e.g., the internet) via a port 127. The connectivity to the external network may be established via a wired connection or a wireless connection, which may use a cellular protocol such as a 2G, 3G, or 4G LTE protocol. The access point 120 may, for example, be an internet gateway router that may comprise a wireless transceiver 123 to provide wireless connectivity (e.g., Wi-Fi) to local devices in addition to the PLC connectivity described below. The access point 120 may additionally or alternatively comprise a wired transceiver (not shown) to provide wired connectivity (e.g., Ethernet) to local devices. In some embodiments, the access point 120 may utilize HomePlug® Access Broadband Power Line (BPL) protocols for coupling to a broadband backhaul network using the wiring of a public powerline infrastructure. Storage 128 may store computer executable instructions associated with any of the elements of FIG. 1.

The access point 120 may have a PLC modem 129 that enables it to transmit and receive messages over a plurality of PLC channels 132, 136, 134, forming a PLC network 110. The PLC network 110 may utilize an existing powerline infrastructure, and communications within the PLC network 110 may be implemented using a PLC protocol such as the HomePlug® 1.0, HomePlug® AV2, or the HomePlug® Green PHY protocols. PLC networks use multiple channels on a communication channel to send information from a transmitting device on the network to receiving device on the network. Each channel may be associated with multiple carriers, and each of the multiple carriers may be associated with a distinct frequency. For example, the HomePlug® AV2 standard uses carriers in the approximately 1.8-86 MHz frequency spectrum. A high bandwidth channel (e.g., approximately 100-500 MHz) may be used to increase the number of carriers available for transmitting information on the channel. As used herein, a carrier may also refer to a sub-carrier, which may be a mini-carrier located in a carrier.

The access point 120 may communicate with a video streaming device 122 via the channel 132. The video streaming device 122 may deliver video data to a television 150 via a wired PLC or non-PLC channel 152, or wireless non-PLC channel 152. The access point 120 may further communicate with a range extender 124 via a PLC channel 134 or a wireless channel. The range extender 124 may serve to extend the range of the home network provided, at least in part, by the access point 120. For example, if the access point 120 provides a Wi-Fi network having a limited range, the range extender 124 could be established at a location to extend the range of Wi-Fi connectivity. Alternatively, the range extender 124 could provide wired connectivity at a separate location from the access point 120. As shown in FIG. 1, the range extender 124 may provide a connection 142 (e.g., Wi-Fi) to a mobile device 140. The range extender 124 may effectively act as a bridge between the PLC network and another network (e.g., Wi-Fi network).

The access point 120 may further communicate with a personal computer 126 via the PLC channel 136. The computer 126 may comprise or be connected to its own PLC modem that sends and receives signals on the PLC channel 136. The computer 126 may be used for a variety of applications that utilize local and/or internet connectivity including gaming, media sharing, and internet browsing. A network coordination processor 121 may implement a control strategy associated with the PLC network 110.

The various channels described with respect to FIG. 1 may have multiple carriers having corresponding frequencies. A channel carries one or more bits of information or data between a transmitting device (e.g., an access point 120) and a receiving device (e.g., a personal computer 126). Transmitting devices and receiving devices on a network negotiate which carriers may be used to carry information (e.g., message payloads) and the bitrate for each carrier. This information may be codified in a tone map that is sent from the transmitting device to the receiving device prior to a message payload transmission from the transmitting device to the receiving device. The transmitting or receiving device may select, either singly or in combination with each other, the carrier-specific bitrates (e.g., the values conveyed in the tone map) based on an estimated channel quality metric for each carrier. If a carrier has a channel quality metric that is insufficient for sending even a single bit, as is possible through Binary Phase Shift Keying (BPSK), the transmitting or receiving device may determine not to use that carrier (e.g., by setting the carrier's bitrate value to 0 in the tone map).

Messages transmitted between a transmitting device and a receiving device may each begin with a preamble followed by a message payload. The preamble may comprise information that is known to the receiving device to precede each message payload. After the preamble is detected or determined by the receiving device, the transmitting and receiving devices negotiate which carriers will be used to transmit the message payload, and a bitrate associated with each carrier. As used herein, the terms “detect” and “determine” may be used interchangeably. If the receiving device does not detect the preamble, it will also fail to prepare for the message payload transmission. Thus, the preamble can be a communication bottleneck, and robust preamble detection is desirable.

Commonly, preamble detection involves inspecting multiple available carriers in a channel for a preamble symbol, with all carriers being equally considered, and computing detection metrics for each of the multiple available carriers in the channel. A carrier on the channel may be unavailable or not suitable for carrying the preamble if the carrier has high signal attenuation and/or high noise levels. If multiple carriers on a channel are considered or weighted equally by the receiving device when detecting a preamble, weak carriers (e.g., carriers with channel quality metrics less than a threshold channel quality metric) may decrease the average channel quality metric of the channel such that a preamble symbol may not be detected at the receiving device. As used herein, a symbol may refer to any quantum of information.

The present disclosure provides techniques for improving preamble detection in a channel (e.g., a high bandwidth channel which may be a channel associated with a bandwidth of approximately 100-500 MHz). Improving preamble detection is achieved by selecting carriers for preamble detection based on channel quality metrics associated with those carriers. This repeated transmission of the preamble symbol provides the receiving device multiple opportunities to detect at least one preamble symbol and prepare for the message payload transmission from the transmitting device. Preamble detection at the receiving device allows synchronization between the receiving device and the transmitting device. In some embodiments, the synchronization may be achieved even if the receiving device misses a previously transmitted preamble symbol from the transmitting device.

The receiving device scans a band of frequencies associated with a channel between the receiving device and the transmitting device. The band may be selected based on an average channel quality metric of the carriers in the band being equal to or greater than a threshold channel quality metric. Alternatively or additionally, the band may be selected based on the channel quality metric associated with each carrier in the band being equal to or greater than the threshold channel quality metric. The receiving device may detect the preamble symbol on at least one carrier in the band.

The receiving device may also perform a noise analysis (e.g., in the frequency domain) for the various carriers on the channel. For example, by repeatedly detecting the same preamble symbol across one or more carriers, a receiving device may observe variations (amplitude and phase variations) caused by noise on each carrier by comparing multiple received preamble symbols. Using the amplitude and phase variations, the receiving device may be able to determine the channel quality metric of each carrier. In some embodiments, the channel quality metric (e.g., an SNR) of a carrier may be determined based on calculating the root-mean-squared (RMS) value of the variations in the received preamble symbols on multiple carriers. Additionally, any narrow band interference (e.g., radio transmission) on carriers may be identified by observing that the received preamble symbol on a particular carrier has a larger (e.g., at least two times) amplitude compared to the received preamble symbols on other carriers. The channel quality metric information together with the narrow band interference detection mechanism may be used to limit the carriers that are scanned at the receiving device for preamble symbol detection. For example, carriers with low channel quality metrics (e.g., less than a threshold channel quality metric) may be ignored when listening for a subsequent preamble symbol. The signals, comprising the preamble symbols, on the remaining carriers which are not ignored, are correlated and compared against a known preamble symbol. If the signals (e.g., at least one signal, at least two signals, or at least three signals, etc.) match the known preamble symbol, the receiving device determines the start of a data packet transmission (e.g., a message payload transmission). In some embodiments, the receiving device determines that the signals match the known preamble symbol if a degree of matching between the signals and the known preamble symbol is greater than or equal to a threshold degree of confidence.

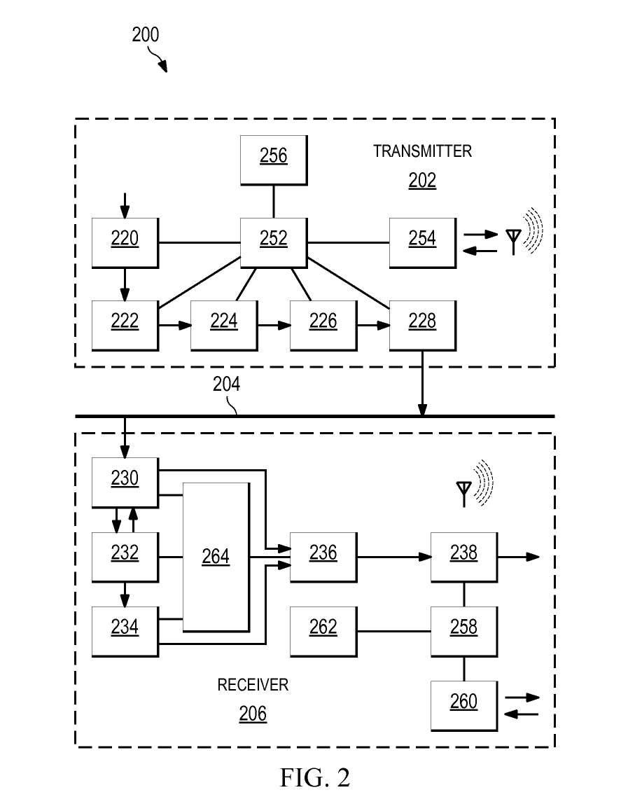

FIG. 2 shows a block diagram illustrating a communication system 200 for communicating over a network. Within the communication system 200, a transmitting device or transmitter 202 may transmit a signal (e.g., a sequence of orthogonal frequency-division multiplexing (OFDM) symbols) over a communication medium 204 to a receiving device or receiver 206. A symbol may include one or more bits. The transmitting device 202 and receiving device 206 may both be incorporated into any of the nodes of a network (e.g., a PLC network of FIG. 1). The communication medium 204 may represent a path or channel from one node to another (e.g., over the powerline infrastructure). The communication system 200 and elements of the communication system 200 are for exemplary purposes only.

At the transmitting device 202, modules implementing the physical layer receive a MAC protocol data unit (MPDU) from the MAC layer. The MAC protocol data unit is sent to an encoder module 220 to perform processing of the MPDU such as scrambling, error correction coding, and interleaving.

The encoded data is fed into a mapping module 222 that takes groups of data bits (e.g., 1, 2, 3, 4, 6, 8, or 10 bits), depending on the constellation used for the current symbol (e.g., a BPSK, QPSK, 8-QAM, 16-QAM constellation), and maps the data value represented by those bits onto the corresponding amplitudes of in-phase (I) and quadrature-phase (Q) components of a carrier waveform of the current symbol. This results in each data value being associated with a corresponding complex number Cᵢ=Aᵢ exp(jΦᵢ) whose real part corresponds to the in-phase component and whose imaginary part corresponds to the quadrature-phase component of a carrier with a peak frequency, fᵢ. Alternatively, any appropriate modulation scheme that associates data values to modulated carrier waveforms may be used.

The mapping module 222 also determines which of the carrier frequencies f₁, f₂, f₃, . . . , f_{N} within the OFDM bandwidth are used by the system 200 to transmit information. For example, some carriers that are experiencing fades can be avoided, and no information is transmitted on those carriers. Instead, the mapping module 222 uses coherent BPSK modulated with a binary value from the Pseudo Noise (PN) sequence for that carrier. In some embodiments, the mapping module 222 determines carriers for transmitting preamble symbols, and a bit rate for each carrier. For some carriers (e.g., a carrier i=10) that correspond to restricted bands (e.g., an amateur radio band) on the communication medium 204 that may radiate power, substantially no energy may be transmitted on those carriers (e.g., by setting A₁₀=0). The mapping module 222 also determines the type of modulation to be used on each of the carriers (or “tones”) according to a tone map. The tone map can be a default tone map, or a customized tone map determined by the receiving device.

An inverse discrete Fourier transform (IDFT) module 224 performs the modulation of the resulting set of N complex numbers (some of which may be zero for unused carriers) determined by the mapping module 222 onto N orthogonal carrier waveforms having peak frequencies f₁, f₂, f₃, . . . , f_{N}. The modulated carriers are combined by the IDFT module 224 to form a discrete time symbol waveform S(n) (for a sampling rate f_{R}), which can be written as

$$S ( n ) = 10 {\sum }_{i = 1}^{N} {A}_{i} exp [ j ( 2 π n / N + {Φ}_{i} ) ] \qquad Eq . ( 1 )$$

where the time index n goes from 1 to N, Aᵢ is the amplitude and Φᵢ is the phase of the carrier with peak frequency fᵢ=(i/N)f_{R}, and j=√−1. In some embodiments, the discrete Fourier transform corresponds to a fast Fourier transform (FFT) in which N is a power of 2.

A processing module 226 combines a sequence of consecutive (potentially overlapping) symbols into a symbol set that can be transmitted as a continuous block over the communication medium 204. The processing module 226 prepends a preamble to the symbol set that can be used for automatic gain control (AGC) and symbol timing synchronization. To mitigate intersymbol and intercarrier interference (e.g., due to imperfections in the system 200 and/or the communication medium 204), the processing module 226 can extend each symbol with a cyclic prefix that is a copy of the last part of the symbol. The processing module 226 can also perform other functions such as applying a pulse shaping window to subsets of symbols within the symbol set (e.g., using a raised cosine window or other type of pulse shaping window) and overlapping the symbol subsets.

An analog front end (AFE) module 228 couples an analog signal comprising a continuous-time (e.g., low-pass filtered) version of the symbol set to the communication medium 204. The effect of the transmission of the continuous-time version of the waveform S(t) over the communication medium 204 can be represented by convolution with a function g(τ;t) representing an impulse response of transmission over the communication medium. The communication medium 204 may add noise n(t), which may be random noise and/or narrowband noise emitted by a jammer.

At the receiving device 206, modules implementing the physical layer receive a signal from the communication medium 204 and generate a MAC protocol data unit for the MAC layer. An AFE module 230 operates in conjunction with an automatic gain control (AGC) module 232 and a time synchronization module 234 to provide sampled signal data and timing information to a discrete Fourier transform (DFT) module 236.

After removing the cyclic prefix, the receiving device 206 feeds the sampled discrete-time symbols into DFT module 236 to extract the sequence of N complex numbers representing the encoded data values (by performing an N-point DFT). A demodulator/decoder module 238 maps the complex numbers onto the corresponding bit sequences and performs the appropriate decoding of the bits (including de-interleaving and descrambling).

Any of the modules of the communication system 200 including modules in the transmitting device 202 or receiving device 206 can be implemented in hardware, software, or a combination of hardware and software. Where a module is implemented, at least in part, in software, the software may be stored in a non-volatile, machine-readable medium.

While the communication medium has generally been described as a powerline infrastructure, alternative implementations may also use the phone lines or coaxial cables (e.g., inside a house) as a communication medium. In some cases, there could be variation in signal attenuation and noise characteristics between various pairs of nodes. In such cases, systems may use channel adaptation procedures that enable selection of unique physical layer encoding parameters (e.g., modulation rate and forward error correction code rate) between a given pair of nodes. This approach enables optimization of the physical data rate that can be achieved between the pair of nodes according to current channel characteristics.

In some embodiments, the channel characteristics depend on an attenuation (and distortion) of the signal as it propagates from the transmission to the receiving device. The channel characteristics may also depend on noise within the network. The combined effect of signal attenuation (and distortion) and noise may determine the channel capacity that may be achieved between a pair of nodes. Higher channel capacity allows for more data intensive applications to be supported and/or for lower noise emissions by allowing decreased transmission power. The channel characteristics may also determine quality of a channel or how reliably information is transmitted across the channel. Channel quality metrics may include, for example, SNR, BER, symbol error rate (SER), etc. In general, a low quality channel is prone to distorting the messages it conveys while a high quality channel preserves the integrity of the messages it conveys. In some embodiments, the quality of the channel in use between communicating entities governs the probability of the receiving device correctly receiving the message from the transmitting device.

A processor 252 may control any of the other modules and/or functions performed by the various modules in the transmitting device 202. A processor 264 or 258 may control any of the other modules and/or functions performed by the various modules in the receiving device 206. While processors 264 and 258 are shown separately, they could either represent distinct processors or a single processor. Any actions described as being taken by a processor may be taken by the processor alone or by the processor in conjunction with one or more additional components. Additionally, while only one processor may be shown in certain devices, multiple processors may be present. Thus, while instructions may be discussed as being executed by a processor, the instructions may be executed simultaneously, serially, or otherwise by one or multiple processors. A processor may be implemented as one or more CPU chips and may be a hardware device capable of executing computer instructions. The processor may execute instructions, codes, computer programs, or scripts. The instructions, codes, computer programs, or scripts may be received from an I/O module 254 or from memory 256 for the transmitting device 202, and from the I/O module 260 or from memory 262 for the receiving device 206.

As used herein, an I/O module 254 or 260 may include modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. I/O modules may also include liquid crystal displays (LCDs), touch screen displays, keyboards, keypads, switches, dials, mice, track balls, voice recognizers, card readers, paper tape readers, printers, video monitors, or other well-known input/output devices.

As used herein, memory 256 or 262 may include random access memory (RAM), read only memory (ROM), or various forms of secondary storage. RAM may be used to store volatile data and/or to store instructions that may be executed by a processor. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold all working data. Secondary storage may be used to store programs that may be loaded into RAM when such programs are selected for execution.

As used herein, networks, such as a PLC network 110, may represent any form of communication network between connected machines and any other network elements, and may also represent a collection of machines or virtual machines operable to provide cloud computing services to users. Networks may include a public cloud or a private cloud. Networks may include routers, hubs, switches, firewalls, content switches, gateways, call controllers, and/or any other suitable components in any suitable form or arrangement. Networks may include, in whole or in part, one or more secured and/or encrypted Virtual Private Networks (VPNs) operable to couple one or more network elements together by operating or communicating over elements of a public or external communication network. A network as described herein may be a wired or wireless network.

A node may include any device with a network interface, which includes, but is not limited to, a network component, a desktop computer, a laptop, a mobile device, a television, a watch or wristband, a laptop computer, a smart screen, a tablet computer, a desktop computer, an electronic reader, a scanner, a portable media player, a mobile computing device, a mobile phone, a wearable device (e.g., wearable on a user's arm), headgear, a gaming device, or a kiosk. A node may be a virtual machine, computer, device, instance, host, or machine in a networked computing environment. As used herein, the terms node, device, system, and apparatus are equivalent and may be used interchangeably.

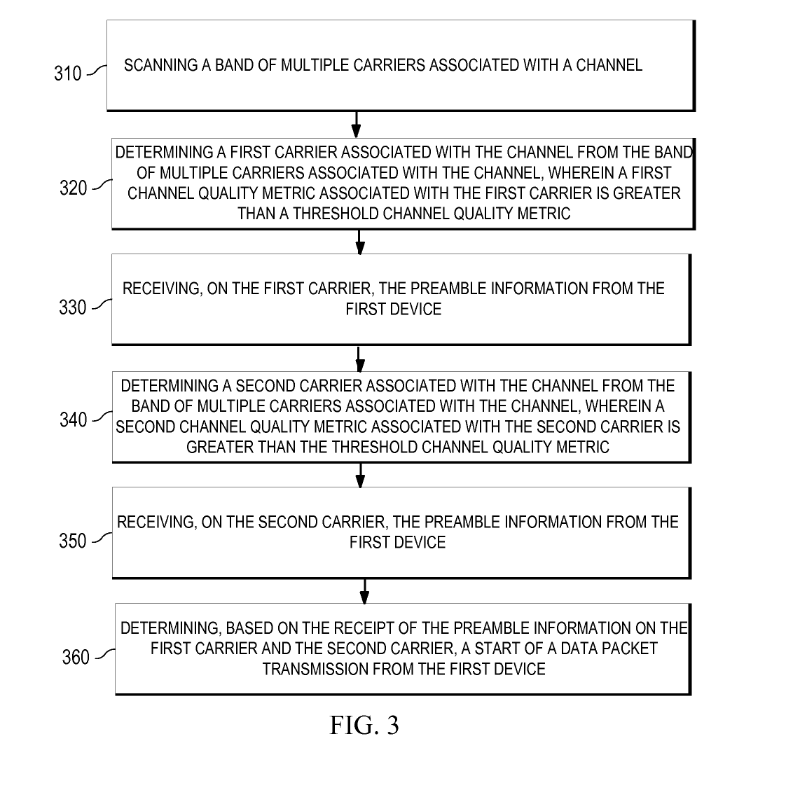

FIG. 3 is a diagram of a method for receiving preamble information (e.g., comprising at least one bit) via a communication channel (e.g., a wired or wireless communication channel) at a second device (e.g., a receiving device or receiver) from a first device (e.g., a transmitting device or transmitter). At block 310, the method comprises scanning a band of multiple carriers associated with the channel. At block 320, the method comprises determining a first carrier associated with the channel from the band of multiple carriers associated with the channel, wherein a first channel quality metric associated with the first carrier is greater than a threshold channel quality metric. At block 330 the method comprises receiving, on the first carrier, the preamble information from the first device. At block 340, the method comprises determining a second carrier associated with the channel from the band of multiple carriers associated with the channel, wherein a second channel quality metric associated with the second carrier is greater than the threshold channel quality metric. At block 350, the method comprises receiving, on the second carrier, the preamble information from the first device. At block 360, the method comprises determining, based on the receipt of the preamble information on the first carrier and the second carrier, a start of a data packet transmission from the first device. In some embodiments, the first carrier and the second carrier are associated with either consecutive or non-consecutive frequencies on the channel. In some embodiments, the method further comprises ignoring a carrier that has a channel quality metric less than the threshold channel quality metric and is associated with the channel, and ignoring a carrier affected by narrow band interference (e.g., equal to or greater than a threshold interference level). In some embodiments, the preamble information is received multiple times at the second device. Each of the multiple copies may be received on different carriers or on the same carrier (e.g., the second carrier or the first carrier). In some embodiments, the transmitter may adapt or change a carrier on which it is transmitting information (e.g., preamble information) based on a change in a condition of the network.

In some embodiments, the method further comprises receiving a variation (e.g., a voltage inversion of the preamble information) of the preamble information from the first device. In some embodiments, the variation is received on the first carrier, the second carrier, or a third carrier associated with the channel. In some embodiments, the variation is received near an end of the reception of the preamble information on the first carrier or the second carrier. Reception of the variation of the preamble information at the second device causes the first and second devices to be synchronized. In some embodiments, the method further comprises receiving message payload information at the second device from the first device (e.g., after the end of the preamble reception). The message payload information may be received after the preamble information is received on both the first and second carriers and after the variation of the preamble information is received at the second device from the first device.

In some embodiments, the method further comprises comparing the preamble information received on the first carrier or the second carrier with known preamble information, and determining whether the preamble information matches (e.g., to a threshold degree of confidence) the known preamble information. In some embodiments, the method further comprises determining the start of a data transmission from the first device or reception at the second device (e.g., a message payload transmission from the first device or reception at the second device) based on determining the preamble information matches (e.g., to a threshold degree of confidence) the known preamble information.

In some embodiments, the method further comprises separating, in a frequency domain, preamble information received on the first carrier from the preamble information received on the second carrier. Unless otherwise specified, the various methods described herein can be performed in a time domain or a frequency domain. Any apparatus as described herein for performing any of the methods described herein may comprise the first device, the second device, or both the first and second devices.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

What is claimed is:

1. An apparatus for receiving preamble information via a channel at a second device from a first device, the apparatus comprising:
an I/O module; and
a processor coupled to the I/O module, the processor configured to:
scan a band of multiple carriers associated with the channel;
determine a first carrier associated with the channel from the band of multiple carriers associated with the channel, wherein a first channel quality metric associated with the first carrier is greater than a threshold channel quality metric;
receive, on the first carrier, the preamble information from the first device;
determine a second carrier associated with the channel from the band of multiple carriers associated with the channel, wherein a second channel quality metric associated with the second carrier is greater than the threshold channel quality metric;
receive, on the second carrier, the preamble information from the first device; and
determine, based on the receipt of the preamble information on the first carrier and the second carrier, a start of a data packet transmission from the first device.

2. The apparatus of claim 1, wherein an average channel quality metric associated with the multiple carriers in the band of multiple carriers is equal to or greater than the threshold channel quality metric.

3. The apparatus of claim 1, wherein the processor is further configured to:
compare the preamble information received on the first carrier and the preamble information received on the second carrier with known preamble information,
determine the preamble information received on the first carrier matches the known preamble information, and
determine the preamble information received on the second carrier matches the known preamble information.

4. The apparatus of claim 1, wherein the first or second channel quality metric comprises a first or second signal-to-noise ratio (SNR) or bit error rate (BER).

5. The apparatus of claim 1, wherein the processor is further configured to measure first amplitude and phase variation associated with the preamble information received on the first carrier, and second amplitude and phase variation associated with the preamble information received on the second carrier, and determine the first channel quality metric for the first carrier based on the first amplitude and phase variation and the second channel quality metric for the second carrier based on the second amplitude and phase variation.

6. The apparatus of claim 1, wherein the processor is further configured to separate, in a frequency domain, the preamble information received on the first carrier from the preamble information received on the second carrier.

7. The apparatus of claim 1, wherein the processor is further configured to:
compare the preamble information received on the first carrier and the preamble information received on the second carrier with known preamble information,
determine a degree of match between the preamble information received on the first carrier and the known preamble information is equal to or greater than a threshold level, and
determine a degree of match between the preamble information received on the second carrier and the known preamble information is equal to or greater than the threshold level.

8. The apparatus of claim 1, wherein the processor is further configured to receive the preamble information on a third carrier, and disregard the third carrier based on determining an amplitude associated with the preamble information received on the third carrier is at least two times greater than an amplitude associated with the preamble information received on the first carrier or the second carrier.

9. The apparatus of claim 1, wherein the processor is further configured to receive message payload information from the first device, the message payload information being received after the preamble information is received on both the first and second carriers.

10. The apparatus of claim 1, wherein the apparatus is integrated into the second device.

11. The apparatus of claim 1, wherein the processor is further configured to compare the preamble information received on the first carrier or the second carrier with known preamble information; and determine whether the preamble information matches the known preamble information.

12. The apparatus of claim 11, wherein the processor is further configured to determine a start of a data transmission based on determining the preamble information received on the first carrier or the second carrier matches the known preamble information.

13. The apparatus of claim 1, wherein the first carrier and the second carrier are associated with non-consecutive frequencies.

14. The apparatus of claim 1, wherein the first carrier and the second carrier are associated with consecutive frequencies.

15. The apparatus of claim 1, wherein the processor is further configured to ignore a carrier affected by narrow band interference equal to or greater than a threshold interference level.

16. A method for receiving preamble information via a channel at a second device from a first device, the method comprising:
scanning, using a computing device processor associated with the second device, a band of multiple carriers associated with the channel;
determining, using the computing device processor, a first carrier associated with the channel from the band of multiple carriers associated with the channel, wherein a first channel quality metric associated with the first carrier is greater than a threshold channel quality metric;
receiving, using the computing device processor, on the first carrier, the preamble information from the first device;
determining, using the computing device processor, a second carrier associated with the channel from the band of multiple carriers associated with the channel, wherein a second channel quality metric associated with the second carrier is greater than the threshold channel quality metric;
receiving, using the computing device processor, on the second carrier, the preamble information from the first device; and
determining, using the computing device processor, based on the receipt of the preamble information on the first carrier and the second carrier, a start of a data packet transmission from the first device.

17. The method of claim 16, further comprising determining an average channel quality metric associated with the multiple carriers in the band of multiple carriers is equal to or greater than the threshold channel quality metric.

18. The method of claim 16, further comprising
comparing the preamble information received on the first carrier and the preamble information received on the second carrier with known preamble information,
determining the preamble information received on the first carrier matches the known preamble information, and
determining the preamble information received on the second carrier matches the known preamble information.

19. The method of claim 16, wherein the preamble information comprises a preamble symbol.

20. The method of claim 16, further comprising measuring first amplitude and phase variation associated with the preamble information received on the first carrier, and second amplitude and phase variation associated with the preamble information received on the second carrier, and determining the first channel quality metric associated with the first carrier based on the first amplitude and phase variation and the second channel quality metric associated with the second carrier based on the second amplitude and phase variation.

21. The method of claim 16, further comprising separating, in a frequency domain, the preamble information received on the first carrier from the preamble information received on the second carrier.

22. The method of claim 16, further comprising:
comparing the preamble information received on the first carrier and the preamble information received on the second carrier with known preamble information,
determining a degree of match between the preamble information received on the first carrier and the known preamble information is equal to or greater than a threshold level, and
determining a degree of match between the preamble information received on the second carrier and the known preamble information is equal to or greater than the threshold level.

23. The method of claim 16, further comprising receiving the preamble information on a third carrier, and disregarding the third carrier based on determining an amplitude associated with the preamble information received on the third carrier is at least two times greater than an amplitude associated with the preamble information received on the first carrier or the second carrier.

24. The method of claim 16, further comprising receiving message payload information from the first device, the message payload information being received after the preamble information is received on both the first and second carriers.

25. The method of claim 16, further comprising comparing the preamble information received on the first carrier or the second carrier with known preamble information; and determining whether the preamble information matches the known preamble information.

26. The method of claim 25, further comprising determining a start of a data transmission based on determining the preamble information matches the known preamble information.

27. The method of claim 16, wherein the first carrier and the second carrier are associated with non-consecutive frequencies.

28. The method of claim 16, further comprising ignoring a carrier affected by narrow band interference equal to or greater than a threshold interference level.

29. A computer readable medium for receiving preamble information via a channel at a second device from a first device, the computer readable medium comprising computer executable code configured to perform:
scanning a band of multiple carriers associated with the channel;
determining a first carrier associated with the channel from the band of multiple carriers associated with the channel, wherein a first channel quality metric associated with the first carrier is greater than a threshold channel quality metric;
receiving, on the first carrier, the preamble information from the first device;
determining a second carrier associated with the channel from the band of multiple carriers associated with the channel, wherein a second channel quality metric associated with the second carrier is greater than the threshold channel quality metric;
receiving, on the second carrier, the preamble information from the first device; and
determining, based on the receipt of the preamble information on the first carrier and the second carrier, a start of a data packet transmission from the first device.

30. An apparatus for receiving preamble information via a channel at a second device from a first device, the apparatus comprising:
means for scanning a band of multiple carriers associated with the channel;
means for determining a first carrier associated with the channel from the band of multiple carriers associated with the channel, wherein a first channel quality metric associated with the first carrier is greater than a threshold channel quality metric;
means for receiving, on the first carrier, the preamble information from the first device;
means for determining a second carrier associated with the channel from the band of multiple carriers associated with the channel, wherein a second channel quality metric associated with the second carrier is greater than the threshold channel quality metric;
means for receiving, on the second carrier, the preamble information from the first device; and
means for determining, based on the receipt of the preamble information on the first carrier and the second carrier, a start of a data packet transmission from the first device.
